(19) United States
(12) Patent Application Publication
(10) Pub. No.: US 2004/0125707 A1
(43) Pub. Date: Jul. 1, 2004

(54) Retrieving content of various types with a conversion device attachable to audio outputs of an audio CD player

(76) Inventor: Rodolfo Vargas, Palo Alto, CA (US)

Correspondence Address: Daniel M Devos, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/117,831

(22) Filed: Apr. 5, 2002

(51) Int. Cl. G11B 7/085

(52) U.S. Cl. 369/30.18

(57) ABSTRACT

A method and apparatus for retrieving different types of content through one or more audio output connectors of an audio CD player is described. In one embodiment of the invention, data carried in Redbook-encoded format is optically read from a CD. The data carried in Redbook-encoded format is Redbook-decoded into data representing converted content of a certain type, which was converted from input data of the same type. The data representing converted content is transmitted out of a CD player device through one or more analog output connectors. In a separate outgoing conversion device detachably coupled with the analog output connectors, the data carried in Redbook-unencoded format is demodulated. The data representing converted content is converted into currently playable reconstructed data approximately representing the input content. The input content may be input video content, input audio content sampled at a higher sampling frequency than a sampling frequency allowed by Redbook-encoded format, input audio content sampled with a larger word length than a word length allowed by Redbook-encoded format, etc.

### FIELD OF THE INVENTION

The invention relates to the field of data storage and retrieval. More specifically, the invention relates to storing and retrieving content of various types with an audio CD.

### BACKGROUND OF THE INVENTION

It is well known that audio content can be stored on and subsequently played from a Compact Disc (“CD”). The processes involved in the storage and playing of audio content relative to a CD are composed of several stages, including encoding and decoding according to a standard specification called the Redbook specification.

The storage process begins with analog audio content referred to herein as “input audio content.” The input audio content is then sampled. The sampling produces “currently playable” data, representing sampled audio content, carried in Redbook-unencoded format (the format acceptable to the Redbook specification for Redbook encoding). This currently playable data is characterized by a certain quality. The data is “currently playable” at that stage because, if presented to a digital-to-analog converter as input, then the digital-to-analog converter would output an analog signal in response that would, if input into a speaker, cause that speaker to produce sound that a human could recognize as being the sampled audio content that the data represents.

The currently playable data, representing sampled audio content, carried in Redbook-unencoded format, is then Redbook-encoded. The Redbook encoding produces data in Redbook-encoded format. The data in Redbook-encoded format is then optically recorded onto the CD.

The playing process begins with the optical reading of the CD. The optical reading produces the same data in Redbook-encoded format that was optically recorded onto the CD earlier. The data in Redbook-encoded format is then Redbook-decoded. This decoding process involves error correction as defined by the Redbook specification. The Redbook decoding produces the same currently playable data, representing sampled audio content, carried in Redbook-unencoded format, as was produced by the sampling discussed above.

Unfortunately, through an inherent effect of the sampling process, the output sampled audio content is of a lower quality than the input audio content referred to above. Quality is affected by sampling frequency and word length. The sampling frequency specified by the Redbook specification is 44.1 kHz. The word length specified by the Redbook specification is 16 bits. By multiplying the sampling frequency by the word length, a bit rate can be obtained. The bit rate is an indicator of quality; the higher the bit rate, the greater the quality of the content.

In an effort to overcome such degradation in quality, the Super Audio CD (“SACD”) specification, among others, was developed. The SACD specification provides for the encoding of higher-quality data (having a higher sampling frequency and a larger word length) than can be encoded by Redbook encoding. However, many existing devices constructed to play audio content represented by data in Redbook-encoded format are incapable of playing audio content represented by data encoded according to the SACD specification.

Another effort to overcome the limitations of Redbook encoding was made with the development of a specification called High Definition Compatible Digital (“HDCD”). According to HDCD, relatively inaudible sounds represented within certain bits of data representing audio content are replaced by more meaningful audio information not otherwise preserved in the sampling discussed above. HDCD encoding produces currently playable data approximately representing sampled audio content; approximately, because a part of that sampled audio content has been substituted by, or replaced with, different audio content not originally found in the sampled audio content. In devices capable of playing audio content represented by data in Redbook-encoded format but incapable of performing HDCD decoding, HDCD-encoded data produces an output that is slightly degraded in comparison to the output produced by non-HDCD-encoded data, such as data in Redbook-encoded format. This degradation is caused by the loss of the audio content that was replaced through HDCD encoding and the inability to interpret the different audio content that was substituted in place of the lost audio content. In a device capable of performing HDCD decoding due to an HDCD decoding unit built-in to that device, HDCD-encoded data produces an output that is of higher quality than the output produced by non-HDCD-encoded data.

To the extent that types of content other than audio content can be stored on and played from a CD, standards different than the Redbook specification have been developed for each different content type. For example, video content, when encoded according to the Whitebook specification, can be stored on a CD. Only a device capable of performing Whitebook decoding is able to correctly play video content that has been Whitebook-encoded. Computer data, including computer-executable code, is encoded according to the Yellowbook specification.

### SUMMARY OF THE INVENTION

A method and apparatus for retrieving different types of content through one or more audio output connectors of an audio CD player is described. In one embodiment of the invention, data carried in Redbook-encoded format is optically read from a CD. The data carried in Redbook-encoded format is Redbook-decoded into data representing converted content of a certain type, which was converted from input data of the same type. The data representing converted content is transmitted out of a CD player device through one or more analog output connectors. In a separate outgoing conversion device detachably coupled with the analog output connectors, the data carried in Redbook-unencoded format is demodulated. The data representing converted content is converted into currently playable reconstructed data approximately representing the input content. The input content may be input video content, input audio content sampled at a higher sampling frequency than a sampling frequency allowed by Redbook-encoded format, input audio content sampled with a larger word length than a word length allowed by Redbook-encoded format, etc.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given element in a Figure is associated with the number of the Figure. However, element numbers are the same for those elements that are the same across different Figures.

FIG. 1A shows a data flow diagram illustrating the storing of content of various types carried in Redbook-encoded format on a CD, according to embodiments of the invention.

FIG. 1B shows a data flow diagram illustrating the retrieving of content of various types carried in Redbook-encoded format from a CD, according to embodiments of the invention.

FIG. 2A shows a block diagram illustrating an incoming conversion device, according to one embodiment of the invention.

FIG. 2B shows a block diagram illustrating an outgoing conversion device detachably coupled with a digital output connector of a CD playing device, according to one embodiment of the invention.

FIG. 3 shows a block diagram illustrating a CD playing device incorporating a post-Redbook-decoding conversion (including decompression) unit, according to one embodiment of the invention.

FIG. 4A shows a data flow diagram illustrating the modulation and storing of content of various types carried in Redbook-encoded format on a CD, according to one embodiment of the invention.

FIG. 4B shows a data flow diagram illustrating the retrieving and demodulation of content of various types carried in Redbook-encoded format from a CD, according to one embodiment of the invention.

FIG. 5A shows a block diagram illustrating an incoming conversion device including a modulation unit, according to one embodiment of the invention.

FIG. 5B shows a block diagram illustrating an outgoing conversion device detachably coupled with analog output connectors of a CD playing device, according to one embodiment of the invention.

### DETAILED DESCRIPTION

In the following description, numerous specific details are set forth to provide a thorough understanding of the invention. However, it is understood that the invention may be practiced without these specific details. In other instances, well-known circuits, structures and techniques have not been shown in detail in order not to obscure the invention. In numerous places below, data is described as being converted, where conversion includes reduction by “compression” or expansion by “decompression”. In each of these cases, the data processing involved in conversion may include inserting data for error correction or extracting the inserted error correction data and using it to correct possible errors in the data stream.

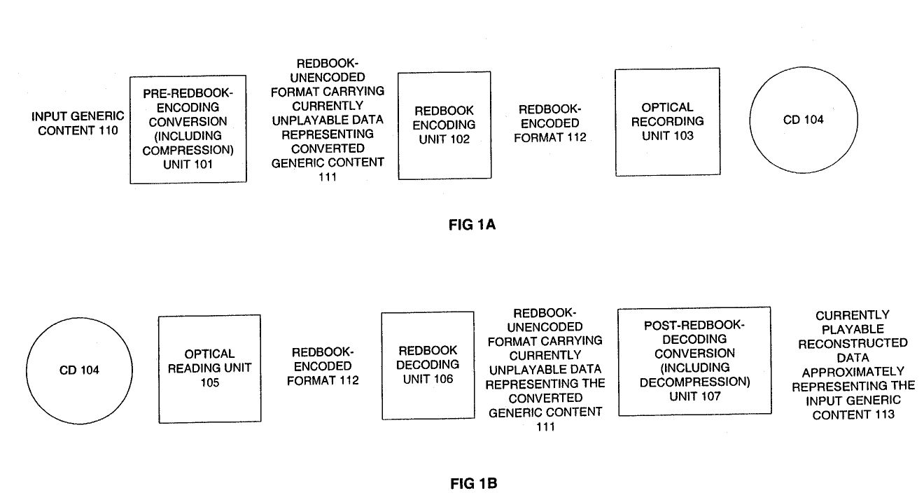

FIG. 1A shows a data flow diagram illustrating the storing of content of various types carried in Redbook-encoded format on a CD, according to embodiments of the invention. In a pre-Redbook-encoding conversion (including compression) unit 101, input generic content 110 is converted into converted generic content represented by currently unplayable data carried in Redbook-unencoded format 111. While in certain embodiments the input generic content 110 is one or more of video content, audio content sampled at a higher sampling frequency than a sampling frequency allowed by Redbook-encoded format, and audio content sampled with a larger word length than a word length allowed by Redbook-encoded format, in alternative embodiments the input generic content 110 can be any content.

Video content may be motion video content or still video content. Still video content is a single image, whereas motion video content includes a sequence of images (often referred to as frames) to be displayed in succession. Motion video content may be full motion video content that, when displayed at a particular frame rate, will appear as “real-time” motion to a human eye. Still video content and each image in motion video content comprise a number of elements referred to as pixels (e.g., a 640×480 image comprises over 300,000 pixels). Each pixel is represented by one or more binary numbers that describe that pixel's characteristics (e.g., color, brightness, etc.). Given the number of pixels in a typical image, storing and/or transmitting uncompressed still or motion video content requires a relatively large amount of computer storage space and/or bandwidth. As such, various compression techniques are often used to reduce the storage space and/or bandwidth requirements.

The conversion performed by pre-Redbook-encoding conversion unit 101 includes compression. Any number of well-known or future developed compression techniques can be used. The specific compression technique used may correspond to the type of input content to be compressed. For example, if the type of input content is motion video content, the compression may be MPEG-4 compression, MPEG-2 compression, MPEG-1 compression, etc. For another example, if the type of content is still video content, the compression may be JIFF compression, TIFF compression, JPEG compression, etc. For yet another example, if the type of content is text, then PKZIP compression may be used.

As stated above, the conversion performed by the pre-Redbook-encoding conversion unit 101 may also include inserting data for error correction. While Redbook encoding, discussed below, provides for some error correction separate from the error correction provided by the pre-Redbook-encoding conversion unit 101, the error correction separately provided by Redbook encoding may not provide sufficient error correction for some types of content. This is chiefly because the error correction provided by Redbook encoding is specifically adapted for audio content. With audio content, an error correction scheme that permits the omission of corrupted data is tolerable; the audio content encoded at one point in time is independent of audio content encoded at any other point in time, and therefore the entire content remains coherent despite any unnoticeable omission of corrupted data. This is not the case with some forms of video content such as motion video content. The video content encoded at one point in time may be dependent upon video content encoded at another point in time (e.g., the encoding of one frame of video may only reference the changes from an earlier frame of video, or several frames may be represented together). As a result, the error correction provided by Redbook encoding, which allows for the omission of corrupted data, is by itself insufficient when used with some types of content. Therefore, with some types of content, error correction data additional to that provided by Redbook encoding is desirable. The error correction data inserted by the pre-Redbook-encoding conversion unit 101 is suitable for use with these types of content. The pre-Redbook-encoding conversion unit 101 may additionally insert an identifier, which may be as small as one bit, that identifies whether error correction data was inserted by pre-Redbook-encoding conversion unit 101. This identifier may also identify a type of error correction data that was inserted. More concerning this error correction data will be disclosed below with regard to a post-Redbook-decoding conversion unit 107.

In a Redbook encoding unit 102, the converted generic content represented by currently unplayable data carried in Redbook-unencoded format 111 is Redbook-encoded into data carried in Redbook-encoded format 112. In an optical recording unit 103, the data carried in Redbook-encoded format 112 is optically recorded onto CD 104. While various embodiments may implement units 102 and 103 differently (including the use of existing components and/or devices), the basic operations of these units are performed according to the well-known Redbook specification. Since the input generic content was converted into currently unplayable data carried in Redbook-unencoded format 111 and stored on a CD according to the Redbook specification, existing CD components and/or devices developed for decoding CDs encoded according to the Redbook specification can be used to produce from the CD 104 the currently unplayable data carried in Redbook-unencoded format 111.

FIG. 1B shows a data flow diagram illustrating the retrieving of content of various types carried in Redbook-encoded format from a CD, according to embodiments of the invention. In an optical reading unit 105, the data carried in Redbook-encoded format 112 is read from the CD 104. In a Redbook decoding unit 106, the data carried in Redbook-encoded format 112 is Redbook-decoded into the converted generic content represented by currently unplayable data carried in Redbook-unencoded format 111. While various embodiments may implement units 105 and 106 differently, the basic operations of these units are performed according to the well-known Redbook specification. Thus, as indicated above, existing CD components and/or devices developed for decoding CDs encoded according to the Redbook specification can be used.

In a post-Redbook-decoding (including decompression) unit 107, the converted generic content represented by currently unplayable data carried in Redbook-unencoded format 111 is converted into currently playable reconstructed data 113 approximately representing the input generic content 110. This conversion includes decompression. In this manner, the Redbook specification is used as a transport for information other than that for which it was intended to be used.

For example, the Redbook specification can be used to transport video content that has been compressed prior to Redbook encoding and storage on the CD, and thus will be correspondingly decompressed after reading retrieval from the CD and Redbook decoding. Because the video content is Redbook-encoded and not necessarily Whitebook-encoded, a Whitebook decoding unit is not required to play video content from a CD. Playing video content from a CD is less expensive than playing video content from a digital video disc (“DVD”) because CDs are typically less expensive than DVDs and CD playing devices are typically less expensive than DVD playing devices.

To provide another example, the Redbook specification can be used to carry higher quality audio content (audio content having a higher bit rate—sampled at a higher sampling frequency than a sampling frequency allowed by Redbook-encoded format or with a larger word length than a word length allowed by Redbook-encoded format, etc.) that has been compressed prior to Redbook encoding and storage on the CD, and thus must correspondingly be decompressed after reading retrieval from the CD and Redbook decoding. However, existing components and/or devices can be used to retrieve and Redbook decode the currently unplayable data, and thus all that is needed is the post-Redbook-decoding conversion unit 107.

As another example, the Redbook specification can be used to carry content that has already been compressed through some compression scheme, such as through a layer of MPEG. This makes possible the storage of more of such content, such as MP3 audio files and/or MPEG video files, on a CD.

As another example, the Redbook specification can be used to carry content that has a larger number of channels than the number of channels than the Redbook specification would usually allow. The Redbook specification usually allows for only 2 channels; a left channel and a right channel, that produce a stereo effect when played. However, according to one embodiment of the invention, the Redbook specification can be used to carry more than 2 channels, producing the effect of audio emanating from various multiple sources surrounding a listener. Adding more channels essentially means increasing the bit rate of the input audio, as each channel carries a number of bits. As discussed above, a greater bit rate can be stored in Redbook-encoded format through the use of compression. Thus, according to one embodiment of the invention, “surround sound” can be carried on a CD in Redbook-encoded format.

The post-Redbook-decoding conversion unit 107 may also use error correction data inserted earlier by the pre-Redbook-encoding conversion unit 101 to correct errors that might have occurred in transmission. The post-Redbook-decoding conversion unit 107 is capable of converting data including this error correction data and also data lacking such error correction data. The post-Redbook-decoding conversion unit 107 may detect whether such error correction data is present by reading an identifier inserted by the pre-Redbook-encoding conversion unit 101 as discussed above. The post-Redbook-decoding conversion device 107 may include a switch or other selective mechanism that can be operated to cause the post-Redbook-decoding conversion device 107 to perform such error correction or to not perform such error correction depending on the current setting of that switch.

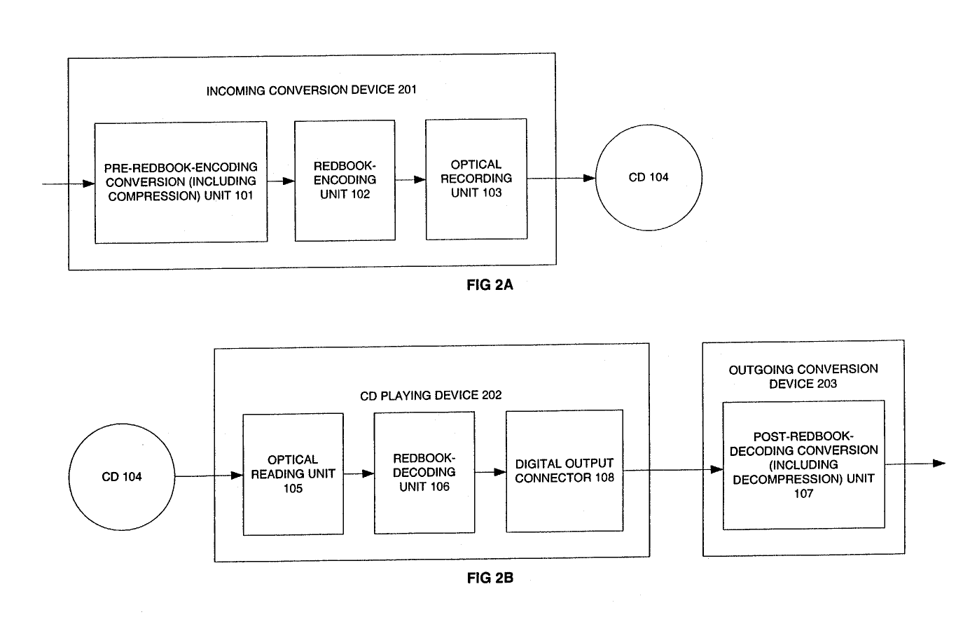

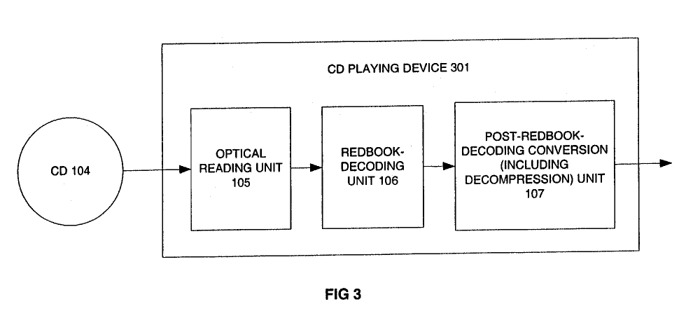

The units of FIGS. 1A and 1B can be implemented in various different device configurations. In fact, certain devices can be implemented which perform operations from both FIGS. 1A and 1B. To provide some examples, FIGS. 2 and 3 will now be described.

FIG. 2A shows a block diagram illustrating an incoming conversion device, according to one embodiment of the invention. The pre-Redbook-encoding conversion (including compression) unit 101 is coupled with the Redbook encoding unit 102. The Redbook-encoding unit 102 is coupled with the optical recording unit 103. The optical recording unit 103 is capable of optically recording data carried in the Redbook-encoded format on a CD 104. While in one embodiment of the invention the pre-Redbook-encoding conversion unit 101, the Redbook encoding unit 102, and the optical recording unit 103 are included in an incoming conversion device 201, in alternative embodiments of the invention these units may be implemented in one or more separate devices.

Many existing CD playing devices include a digital output connector. The digital output connector was designed to connect the output of a CD playing device directly to a digital-to-analog converter external to the CD playing device.

FIG. 2B shows a block diagram illustrating an outgoing conversion device detachably coupled with a digital output connector of a CD playing device, according to one embodiment of the invention. The optical reading unit 105 is capable of optically reading data from the CD 104. The optical reading unit 105 is coupled with the Redbook-decoding unit 106. The Redbook-decoding unit 106 is coupled with a digital output connector 108. The digital output connector 108 is detachably coupled with the post-Redbook-decoding conversion (including decompression) unit 107.

In FIG. 2B the optical reading unit 105, Redbook-decoding unit 106, and digital output connector 108 are included in a CD playing device 202, and the post-Redbook-decoding conversion (including decompression) unit 107 is included in an outgoing conversion device 203 that is separate from CD playing device 202. Outgoing conversion device 203 includes an input, coupled with the post-Redbook-decoding conversion (including decompression) unit 107, to be detachably coupled with the digital output connector 108.

Since the post-Redbook-decoding conversion unit 107 is separate from the CD playing device 202, the CD playing device 202 need not be modified to be able to perform the post-Redbook-decoding conversion, but can be a standard CD playing device designed to handle the Redbook specification that has a digital output connector. Furthermore, although a standard CD playing device is used, different content than was intended to be played by the device can be played through the device with the connecting of the outgoing conversion device 203. For example, where video content was stored, that video content can be played from a CD playing device designed to play only audio. Of course, not only video content, but also audio content of higher quality than has been available from a CD, and various other forms of content, can be played in this manner.

Additionally, the outgoing conversion device 203 can be manufactured and distributed with relatively little expense. In one embodiment of the invention, the outgoing conversion device 203 may be designed to convert a specific type of content (e.g., video). In one embodiment of the invention, outgoing conversion devices 203 could be massively distributed through mail systems. In certain cultures, it is popular to mass-mail CDs containing Whitebook-encoded video content; the substance of the video content may be, among other possibilities, an advertisement or a demonstration. Because the outgoing conversion device 203 can be manufactured inexpensively and in dimensions small enough and lightweight enough to be included with bulk-mailed materials such as magazines and newspapers, CDs such as CD 104 can feasibly be mass-mailed with outgoing conversion device 203, and then played by recipients even if those recipients lack a device capable of performing Whitebook decoding.

The outgoing conversion device 203 can be implemented in a variety of configurations. For example, the outgoing conversion device 203 could include a digital output connector to which a separate device would be detachably coupled. Such a separate device can take on a variety of forms depending on the input video content. For example, the separate device could be a receiver including a digital-to-analog converter, a TV, a monitor, etc. To provide a more detailed example, assume that: 1) an existing system includes a CD playing device (like that of FIG. 2B) whose digital output connector is detachably coupled to a receiver, which in turn has speakers connected to it; 2) that video content with synchronized audio is stored as described herein; and 3) the outgoing conversion device includes a video out connector (S video, analog video, etc.) and an audio output connector. This audio output connector may be an analog audio output connector or a digital audio output connector. The outgoing conversion device 203 is inserted between the CD playing device and the receiver by detachably coupling the digital output connector of the CD playing device to the outgoing conversion device 203 and detachably coupling the audio output connector of the outgoing conversion device to the receiver. In addition, the video out connector of the outgoing conversion device is detachably coupled to a video playing device.

The system of the above example will now play the Redbook specification CD carrying the video with synchronized audio content without the need for replacing/upgrading a device, but rather by simply inserting this relatively inexpensive outgoing conversion device 203.

Furthermore, it should be understood that the outgoing conversion device 203 may or may not be implemented to operate in a bypass mode and/or to switch between different types of content. For example, while one embodiment used in the above exemplary system could be implemented to switch between (e.g., responsive to a manual switch, a command from a remote, automatic detection based on the signal being received, etc.) a bypass mode (for playing audio CDs as the system did prior to the insertion of the outgoing conversion device) and an operating mode (for playing the Redbook specification CD carrying the video with synchronized audio content), alternative embodiments may not include such a bypass mode.

The above audio/video system configuration is merely an example and many other configurations are possible. To provide another example, the outgoing conversion device could be detachably coupled to the video and audio connectors of a TV. The functionality of the receiver referenced in the previous example may be incorporated into the outgoing conversion device 203 itself. This configuration may be especially useful where the CD playing device is portable and transporting a separate receiver is undesirable. In such a configuration, both the video out connector and the audio output connector are detachably coupled to the TV, which includes speakers. To provide another example, the post-Redbook-decoding conversion unit could be part of another device (e.g., receiver, TV, etc), as opposed to a separate device.

FIG. 3 shows a block diagram illustrating a CD playing device incorporating a post-Redbook-decoding conversion (including decompression) unit, according to one embodiment of the invention. The optical reading unit 105 is capable of optically reading data from the CD 104. The optical reading unit 105 is coupled with the Redbook-decoding unit 106. The Redbook-decoding unit 106 is coupled with the post-Redbook-decoding conversion (including decompression) unit 107. In one embodiment of the invention, the optical reading unit 105, Redbook-decoding unit 106, and post-Redbook-decoding conversion (including decompression) unit 107 are included in the CD playing device 301.

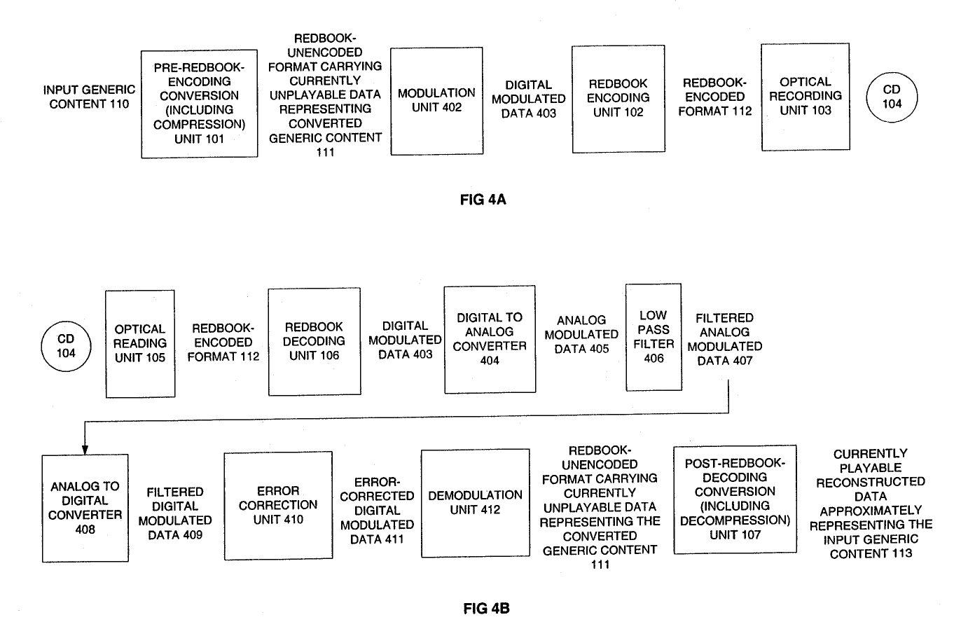

FIG. 4A shows a data flow diagram illustrating the modulation and storing of content of various types carried in Redbook-encoded format on a CD, according to one embodiment of the invention. The data and the units shown are similar to those shown in FIG. 1A but with some intermediate additions. In a modulation unit 402, the converted generic content represented by currently unplayable data carried in Redbook-unencoded format 111 is modulated into digital modulated data 403. This modulation needs not involve a digital to analog conversion. The modulation may be performed with a digital filter. Thus, the data received by modulation unit 402 and the data output by modulation unit 402 may remain in digital form. The modulation may be according to any of the various standard protocols used by modems (e.g., V.34, V.42, etc.). The modulation may involve the addition of error correction codes. However, the modulation unit 402 need not include all of the functionality of a typical modem. The modulation unit operates at a certain bit rate (e.g., 56 kilobits per second). In the Redbook encoding unit 102, the digital modulated data 403 is Redbook-encoded into the data carried in Redbook-encoded format 112. The reasons for performing the modulation will become apparent from the disclosure below.

FIG. 4B shows a data flow diagram illustrating the retrieving and demodulation of content of various types carried in Redbook-encoded format from a CD, according to one embodiment of the invention. The data and the units shown are similar to those shown in FIG. 1B but with some intermediate additions. In the Redbook decoding unit 106, the data carried in Redbook-encoded format 112 is Redbook-decoded into the digital modulated data 403. In a digital-to-analog converter 404, the digital modulated data 403 is converted into analog modulated data 405. In a low-pass filter 406, the analog modulated data 405 is filtered to produce filtered analog modulated data 407. In an analog-to-digital converter 408, the filtered analog modulated data 407 is converted into filtered digital modulated data 409. Through one or more of the operations performed by the preceding units, errors could be introduced into the data discussed. Therefore, in an error correction unit 410, the filtered digital modulated data 409 is error-corrected to produce error-corrected digital modulated data 411. In a demodulation unit 412, the error-corrected digital modulated data 411 is demodulated into the currently unplayable data carried in Redbook-unencoded format 111. The demodulation may be according to any of the various standard protocols used by modems (e.g., V.34, V.42, etc.). However, the demodulation unit 402 need not include all of the functionality of a typical modem. For example, the demodulation unit 402 need not include any functionality for echo cancellation such as is found in many standard modems. The demodulation unit operates at a certain bit rate (e.g., 56 kilobits per second). The reasons for performing the demodulation will become apparent from the disclosure below.

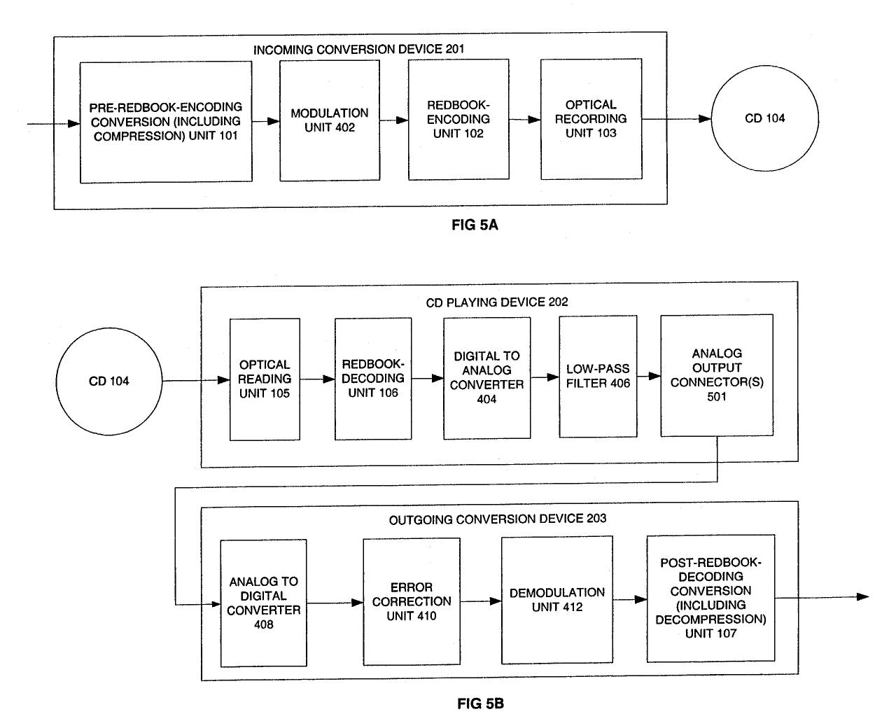

The units of FIGS. 4A and 4B can be implemented in various different device configurations. In fact, certain devices can be implemented which perform operations from both FIGS. 4A and 4B. To provide some examples, FIGS. 5A and 5B will now be described.

FIG. 5A shows a block diagram illustrating an incoming conversion device including a modulation unit, according to one embodiment of the invention. The pre-Redbook-encoding conversion (including compression) unit 101 is coupled with the modulation unit 402. The modulation unit 402 is coupled with the Redbook encoding unit 102. The Redbook-encoding unit 102 is coupled with the optical recording unit 103. The optical recording unit 103 is capable of optically recording data carried in the Redbook-encoded format on a CD 104. While in one embodiment of the invention the pre-Redbook-encoding conversion unit 101, the modulation unit 402, the Redbook encoding unit 102, and the optical recording unit 103 are included in an incoming conversion device 201, in alternative embodiments of the invention these units may be implemented in one or more separate devices.

Many existing CD playing devices include one or more analog output connectors. The analog output connectors were designed to connect the output of a CD playing device directly to a speakers or headphones external to the CD playing device.

FIG. 5B shows a block diagram illustrating an outgoing conversion device detachably coupled with one or more analog output connectors of a CD playing device, according to one embodiment of the invention. The optical reading unit 105 is capable of optically reading data from the CD 104. The optical reading unit 105 is coupled with the Redbook-decoding unit 106. The Redbook-decoding unit 106 is coupled with the digital-to-analog converter 404. The digital-to-analog converter 404 is coupled with the low-pass filter 406. The low-pass filter 406 is coupled with one or more analog output connectors 501. The analog output connector(s) 501 are detachably coupled with the analog-to-digital converter 408. The analog-to-digital converter 408 is coupled with the error correction unit 410. The error correction unit 410 is coupled with the demodulation unit 412. The demodulation unit 412 is coupled with the post-Redbook-decoding conversion (including decompression) unit 107.

In FIG. 5B the optical reading unit 105, Redbook-decoding unit 106, the digital-to-analog converter 404, the low-pass filter 406, and analog output connector 108 are included in a CD playing device 202, and the analog-to-digital converter 408, error correction unit 410, demodulation unit 412, and post-Redbook-decoding conversion (including decompression) unit 107 are included in an outgoing conversion device 203 that is separate from CD playing device 202. Outgoing conversion device 203 includes an input, coupled with the analog-to-digital converter 408, to be detachably coupled with the analog output connector(s) 501. Analog output connectors 501 may include one or more analog audio output connectors (e.g., a left and a right connector). For example, analog output connectors 501 may be RCA connectors. In alternative embodiments of the invention the above units may be implemented in one or more separate devices. Specifically, in alternative embodiments of the invention, one or more of the analog-to-digital converter 408, the error correction unit 410, the demodulation unit 412, and the post-Redbook-decoding decompression unit 107 may be included in a digital signal processor (“DSP”) and/or implemented in software.

The embodiment of the invention shown in FIG. 5B operates similarly to the embodiment of the invention shown in FIG. 1B above. However, instead of using the digital output connector 108 of FIG. 1B, the embodiment of the invention shown in FIG. 5B uses analog output connector(s) 501. Therefore, even a CD playing device that lacks a digital output connector may be detachably coupled with an outgoing conversion device 203 to operate similarly to the embodiment of the invention shown in FIG. 1B above. The demodulation unit 412 demodulates the signals transmitted through the analog output connector(s) 501 into signals usable by the post-Redbook-decoding conversion (including decompression) unit 107. Therefore, the post-Redbook-decoding conversion (including decompression) unit 107 need not be modified from the unit shown in FIG. 1B in order to be used in the embodiment of the invention shown in FIG. 5B. In one embodiment of the invention, outgoing conversion device 203 includes both an digital input to be detachably coupled to a digital output connector of a CD playing device, such as is shown in FIG. 1B, and one or more audio inputs to be detachably coupled to analog output connectors of a CD playing device, such as is shown in FIG. 5B.

The methodologies described herein may be performed by machines, and such machines may be caused to perform these methodologies by executing instructions included in a machine-readable medium. Such machines may include computer systems. An exemplary computer system includes a processor coupled to a storage device by a bus. The storage device may be a hard disk drive, a CD drive, etc. In addition, a number of user input/output devices, such as a keyboard and a display, may also be coupled to the bus. A network may also be coupled to the bus. The processor represents a central processing unit of any type of architecture, such as a CISC, RISC, VLIW, or hybrid architecture. In addition, the processor could be implemented on one or more chips. For the purposes of this specification, the term “machine-readable medium” shall be taken to include any mechanism that provides (i.e., stores and/or transmits) information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

While the invention has been described in terms of several embodiments, those skilled in the art will recognize that the invention is not limited to the embodiments described. The method and apparatus of the invention can be practiced with modification and alteration within the spirit and scope of the appended claims. The description is thus to be regarded as illustrative instead of limiting on the invention.

What is claimed is:

1. A method comprising:
optically reading data carried in Redbook-encoded format from a CD, wherein the data was generated by Redbook-encoding data representing converted content carried in Redbook-unencoded format, wherein the converted content was converted from input content;
Redbook-decoding the data carried in Redbook-encoded format into the data carried in Redbook-unencoded format;
transmitting the data carried in Redbook-unencoded format out of a CD player device through at least one analog output connector;
demodulating in a separate outgoing conversion device detachably coupled with the CD player device the data carried in Redbook-unencoded format;
converting in the separate outgoing conversion device the data carried in Redbook-unencoded format into reconstructed data approximately representing the input content.

2. The method of claim 1, wherein the input content is input video content.

3. The method of claim 1, wherein the input content is input audio content sampled at a higher sampling frequency than a sampling frequency allowed by Redbook-encoded format.

4. The method of claim 1, wherein the input content is input audio content sampled with a larger word length than a word length allowed by Redbook-encoded format.

5. The method of claim 1, wherein the input content is input audio content including a larger number of channels than the number of channels allowed by Redbook-encoded format.

6. The method of claim 1, wherein the converting includes decompressing.

7. The method of claim 6, wherein the compressing is according to MPEG-4 decompression.

8. The method of claim 1, wherein the converting includes performing error correction using error correction codes included in the data carried in Redbook-unencoded format.

9. An apparatus comprising:
a device including,
at least one input to be detachably coupled with at least one analog output connector of a separate CD playing device;
an analog-to-digital converter coupled with the at least one input;
an error correction unit coupled with the analog-to-digital converter;
a demodulation unit coupled with the error correction unit to receive modulated data that was generated by converting input content and to produce therefrom demodulated data; and
a post-Redbook-decoding conversion unit coupled with the demodulation unit to receive the demodulated data and to produce therefrom reconstructed data approximately representing the input content.

10. The apparatus of claim 9, wherein the input content is input video content.

11. The apparatus of claim 9, wherein the input content is input audio content sampled at a higher sampling frequency than a sampling frequency allowed by Redbook-encoded format.

12. The apparatus of claim 9, wherein the input content is input audio content sampled with a larger word length than a word length allowed by Redbook-encoded format.

13. The apparatus of claim 9, wherein the input content is input audio content including a larger number of channels than the number of channels allowed by Redbook-encoded format.

14. The apparatus of claim 9, wherein the device includes a digital output connector to which a separate device can be detachably coupled.

15. The apparatus of claim 14, wherein the separate device is a digital-to-analog converter.

16. The apparatus of claim 14, wherein the separate device is a TV.

17. The apparatus of claim 14, wherein the device includes a video out connector and an audio output connector.

18. The apparatus of claim 17, wherein the audio output connector is detachably coupled to a digital-to-analog converter and the video out connector is detachably coupled to a video playing device.

19. The apparatus of claim 17, wherein the audio output connector is detachably coupled to an audio connector of a TV and the video out connector is detachably coupled to a video connector of the TV.

20. A method comprising:
converting input content into converted content;
modulating the converted content into modulated data;
Redbook-encoding the modulated data into data carried in Redbook-encoded format; and
optically recording the data carried in Redbook-encoded format onto a CD.

21. The method of claim 20, wherein the input content is input video content.

22. The method of claim 20, wherein the input content is input audio content sampled at a higher sampling frequency than a sampling frequency allowed by Redbook-encoded format.

23. The method of claim 20, wherein the input content is input audio content sampled with a larger word length than a word length allowed by Redbook-encoded format.

24. The method of claim 20, wherein the input content is input audio content including a larger number of channels than the number of channels allowed by Redbook-encoded format.

25. An apparatus comprising:
a pre-Redbook-encoding conversion unit to be coupled to receive input content and produce therefrom converted data representing the input content;
a modulation unit coupled with the pre-Redbook-encoding conversion unit to receive the converted data representing the input content and produce therefrom modulated data;
a Redbook encoding unit coupled with the pre-Redbook-encoding conversion unit to receive modulated data; and
an optical recording unit coupled with the Redbook encoding unit to receive data carried in Redbook-encoded format and cause the data carried in Redbook-encoded format to be optically recorded onto a CD.

26. The apparatus of claim 25, wherein the pre-Redbook-encoding conversion unit, the modulation unit, the Redbook encoding unit, and the optical recording unit are included in an incoming conversion device.

27. The apparatus of claim 25, wherein the pre-Redbook-encoding conversion unit and the modulation unit are included in an incoming conversion device and the Redbook encoding unit and the optical recording unit are included in a device separate from the incoming conversion device.
